(19) United States
(12) Patent Application Publication
(10) Pub. No.: US 2020/0381749 A1
(43) Pub. Date: Dec. 3, 2020

(54) FUEL CELL AND MANUFACTURING METHOD OF FUEL CELL

(71) Applicant: TOYOTA JIDOSHA KABUSHIKI KAISHA, Toyota-shi (JP)

(72) Inventors: Kenji SATO, Kasugai-shi (JP); Yuto TAMURA, Toyota-shi (JP); Tomoo YOSHIZUMI, Toyota-shi (JP)

(73) Assignee: TOYOTA JIDOSHA KABUSHIKI KAISHA, Toyota-shi (JP)

(21) Appl. No.: 16/865,775

(22) Filed: May 4, 2020

(30) Foreign Application Priority Data
May 27, 2019 (JP) 2019-098429

(51) Int. Cl. H01M 8/0273; H01M 8/1004; H01M 8/242

(52) U.S. Cl. CPC H01M 8/0273; H01M 8/242; H01M 8/1004

(57) ABSTRACT

A first resin frame of a power generation cell includes a fuel gas communication structure configured to lead fuel gas to a first surface of a membrane electrode assembly, and an oxidation gas communication structure configured to lead oxidation gas to a second surface of the membrane electrode assembly. A second resin frame of a non-power generation cell includes either one of a fuel gas communication structure configured to lead fuel gas to a conductive member, and an oxidation gas communication structure configured to lead oxidation gas to the conductive member.

The disclosure of Japanese Patent Application No. 2019-098429 filed on May 27, 2019 including the specification, drawings and abstract is incorporated herein by reference in its entirety.

### BACKGROUND

### 1. Technical Field

The present disclosure relates to a fuel cell and a manufacturing method for a fuel cell.

### 2. Description of Related Art

As a fuel cell, there has been proposed a configuration in which a non-power generation cell (a dummy cell) that does not perform power generation is placed in a part of a fuel cell stack including laminated power generation cells. The part of the fuel cell stack is, for example, an end portion of the stack. As the configuration of the fuel cell, the following configuration has been known (for example, see Japanese Unexamined Patent Application Publication No. 2006-147502 (JP 2006-147502 A)). That is, a power generation cell and a non-power generation cell are provided with gaskets having different shapes formed on surfaces of respective gas separators. In the non-power generation cell, the flow of a reactant gas from a manifold into a space inside the non-power generation cell is prevented by such a gasket.

### SUMMARY

However, as described in JP 2006-147502 A, in a case where the flow of a reactant gas into the non-power generation cell is prevented by providing a gasket on the gas separator in the non-power generation cell, the gasket having a different shape from that of a gasket provided in the power generation cell, the forming of the gasket for the non-power generation cell might require dies of a different type from dies for forming the gasket for the power generation cell. This consequently can cause such a problem that a manufacturing cost increases because the dies should be prepared separately.

The present disclosure is achievable in the following aspects.

One aspect of the present disclosure provides a fuel cell. The fuel cell includes a fuel cell stack in which a power generation cell and a non-power generation cell are laminated. The power generation cell is configured to generate electric power upon receipt of supply of fuel gas and oxidation gas, and the non-power generation cell is configured not to generate electric power. The power generation cell includes a pair of first gas separators, a membrane electrode assembly placed between the first gas separators, and a first resin frame configured to hold the membrane electrode assembly by surrounding an outer periphery of the membrane electrode assembly, the first resin frame being sandwiched between the first gas separators. The non-power generation cell includes a pair of second gas separators, a conductive member placed between the second gas separators and making contact with respective inner surfaces of the second gas separators, and a second resin frame surrounding an outer periphery of the conductive member, the second resin frame being sandwiched between the second gas separators. The first resin frame includes a first fuel gas communication structure configured to lead the fuel gas to a first surface of the membrane electrode assembly, and a first oxidation gas communication structure configured to lead the oxidation gas to a second surface of the membrane electrode assembly. The second resin frame includes either one of a second fuel gas communication structure configured to lead the fuel gas to between the second gas separators, and a second oxidation gas communication structure configured to lead the oxidation gas to between the second gas separators. In the fuel cell of the present aspect, it is possible to prevent the flow of fuel gas or oxidation gas to the non-power generation cell by use of a resin frame similar to the resin frame used in the power generation cell. Accordingly, it is not necessary to prepare different types of dies to form gaskets having different shapes. This makes it possible to restrain a manufacturing cost from increasing due to provision of the non-power generation cell. The first resin frame and the second resin frame can be manufactured by simple and easy machining such as punching to frame-shaped members formed in the same manner, thereby making it possible to restrain the manufacturing cost from increasing due to provision of the non-power generation cell. Further, one reactant gas out of fuel gas and oxidation gas flows to between the second gas separators. This makes it possible to increase a water discharge property in a passage where the reactant gas flows.

In the fuel cell of the above aspect, the second resin frame may include the second fuel gas communication structure. A passage constituted by the second fuel gas communication structure may have a part with a sectional area smaller than a sectional area of a passage constituted by the first fuel gas communication structure. With the fuel cell of this aspect, it is possible to increase a passage resistance at the time when fuel gas flows through the non-power generation cell. As a result, it is possible to restrain a decrease in flow rate of fuel gas due to provision of the non-power generation cell, the fuel gas flowing through the power generation cell adjacent to the non-power generation cell or the power generation cell placed near the non-power generation cell. This makes it possible to increase battery performance

In the fuel cell of the above aspect, the second resin frame may include the second oxidation gas communication structure. A passage constituted by the second oxidation gas communication structure may have a part with a sectional area smaller than a sectional area of a passage constituted by the first oxidation gas communication structure. With the fuel cell of this aspect, it is possible to increase a passage resistance at the time when oxidation gas flows through the non-power generation cell. As a result, it is possible to restrain a decrease in flow rate of oxidation gas due to provision of the non-power generation cell, the oxidation gas flowing through the power generation cell adjacent to the non-power generation cell or the power generation cell placed near the non-power generation cell. This makes it possible to increase battery performance

In the fuel cell of the above aspect, the conductive member may be a porous body. With the fuel cell of this aspect, the passage resistance at the time when fuel gas or oxidation gas flows through the non-power generation cell is decreased, thereby making it possible to increase a water discharge property via the non-power generation cell.

Another aspect of the present disclosure provides a fuel cell. The fuel cell includes a fuel cell stack in which a power generation cell and a non-power generation cell are laminated. The power generation cell is configured to generate electric power upon receipt of supply of fuel gas and oxidation gas, and the non-power generation cell is configured not to generate electric power. The power generation cell includes a pair of first gas separators, a membrane electrode assembly placed between the first gas separators, and a first resin frame configured to hold the membrane electrode assembly by surrounding an outer periphery of the membrane electrode assembly, the first resin frame being sandwiched between the first gas separators. The non-power generation cell includes a pair of second gas separators, a conductive member placed between the second gas separators and making contact with respective inner surfaces of the second gas separators, and a second resin frame surrounding an outer periphery of the conductive member, the second resin frame being sandwiched between the second gas separators. The first resin frame includes a first fuel gas communication structure configured to lead the fuel gas to a first surface of the membrane electrode assembly, and a first oxidation gas communication structure configured to lead the oxidation gas to a second surface of the membrane electrode assembly. The second resin frame blocks introduction of the fuel gas to between the second gas separators and introduction of the oxidation gas to between the second gas separators. With the fuel cell of this aspect, it is possible to block the flows of fuel gas and oxidation gas into the non-power generation cell by use of a resin frame similar to the resin frame used in the power generation cell. Accordingly, it is not necessary to prepare different types of dies to form gaskets having different shapes. This makes it possible to restrain a manufacturing cost from increasing due to provision of the non-power generation cell. The first resin frame and the second resin frame can be manufactured by simple and easy machining such as punching to frame-shaped members formed in the same manner, thereby making it possible to restrain the manufacturing cost from increasing due to provision of the non-power generation cell. Further, since the flows of the reactant gases to between the second gas separators are blocked, it is possible to reduce energy necessary to supply the reactant gases to the non-power generation cell.

The present disclosure is achievable in various forms other than the above aspects. For example, the present disclosure is achievable in the form of a manufacturing method for a fuel cell, a non-power generation cell for a fuel cell, a manufacturing method for a non-power generation cell, or the like.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view of a fuel cell stack;

FIG. 2 is an exploded perspective view illustrating a schematic configuration of a power generation cell;

FIG. 3 is a plan view of a gas separator;

FIG. 4 is an exploded perspective view illustrating a schematic configuration of a non-power generation cell;

FIG. 5 is a sectional schematic view illustrating a state near a manifold hole for oxidation gas in the non-power generation cell.

FIG. 6 is a sectional schematic view illustrating a state near a manifold hole for fuel gas in the non-power generation cell.

FIG. 7 is a process drawing illustrating a manufacturing method for a fuel cell;

FIG. 8 is a sectional schematic view illustrating a state of a part including a slit portion in the power generation cell;

FIG. 9 is a sectional schematic view illustrating a state of a part including a slit portion in the non-power generation cell;

FIG. 10 is a sectional schematic view illustrating a state of a part including the slit portion in the non-power generation cell;

FIG. 11 is a sectional schematic view illustrating a state of a part including the slit portion in the non-power generation cell;

FIG. 12 is a sectional schematic view illustrating a state of a part including the slit portion in the non-power generation cell;

FIG. 13 is an exploded perspective view illustrating a schematic configuration of a non-power generation cell;

FIG. 14 is an exploded perspective view illustrating a schematic configuration of a non-power generation cell;

FIG. 15 is an explanatory view illustrating a schematic configuration of a fuel cell stack; and

FIG. 16 is an explanatory view illustrating a schematic configuration of a fuel cell stack.

### DETAILED DESCRIPTION OF EMBODIMENTS

### A. First Embodiment

### (A-1) Overall Configuration of Fuel Cell:

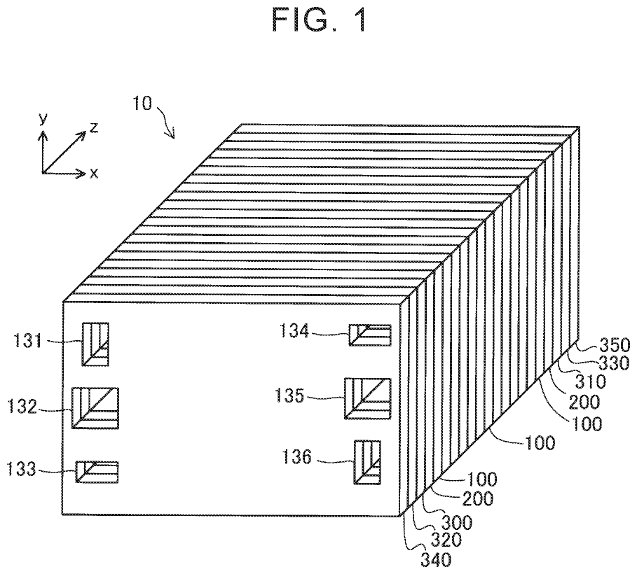

FIG. 1 is a perspective view illustrating an outline of the appearance of a fuel cell stack 10 provided in a fuel cell as a first embodiment of the present disclosure. The fuel cell of the present embodiment is a solid polymer fuel cell but can be other types of fuel cells such as a solid oxide fuel cell. The fuel cell stack 10 includes a plurality of power generation cells 100, two non-power generation cells 200, current collector plates 300, 310, insulating plates 320, 330, and end plates 340, 350. One of the two non-power generation cells 200 is placed on a first side of the laminated power generation cells 100, and the other one of the two non-power generation cells 200 is placed on a second side of the laminated power generation cells 100. The current collector plate 300, the insulating plate 320, and the end plate 340 are laminated in this order on an outer side of the one of the two non-power generation cells 200, and the current collector plate 310, the insulating plate 330, and the end plate 350 are laminated in this order on an outer side of the other one of the two non-power generation cells 200. As illustrated in FIG. 1, in the present embodiment, the width direction of the fuel cell stack 10 is indicated by an x-direction, the height direction of the fuel cell stack 10 is indicated by a y-direction, and the laminating direction of the fuel cell stack 10 is indicated by a z-direction.

In the fuel cell stack 10, as manifolds penetrating through the fuel cell stack 10 and extending in the laminating direction of the fuel cell stack 10, an oxidation gas supply manifold 131, an oxidation gas discharge manifold 136, a fuel gas supply manifold 134, a fuel gas discharge manifold 133, a refrigerant supply manifold 132, and a refrigerant discharge manifold 135 are provided. The oxidation gas supply manifold 131 is a manifold via which oxidation gas (e.g., air) is supplied to each power generation cell 100, and the oxidation gas discharge manifold 136 is a manifold via which cathode offgas discharged from each power generation cell 100 gathers. The fuel gas supply manifold 134 is a manifold via which fuel gas (e.g., hydrogen gas) is supplied to each power generation cell 100, and the fuel gas discharge manifold 133 is a manifold via which anode offgas discharged from each power generation cell 100 gathers. The refrigerant supply manifold 132 is a manifold via which refrigerant is supplied to inter-cell refrigerant passages provided between the power generation cells 100, and the refrigerant discharge manifold 135 is a manifold via which the refrigerant discharged from each inter-cell refrigerant passage gathers.

### (A-2) Structure of Power Generation Cell:

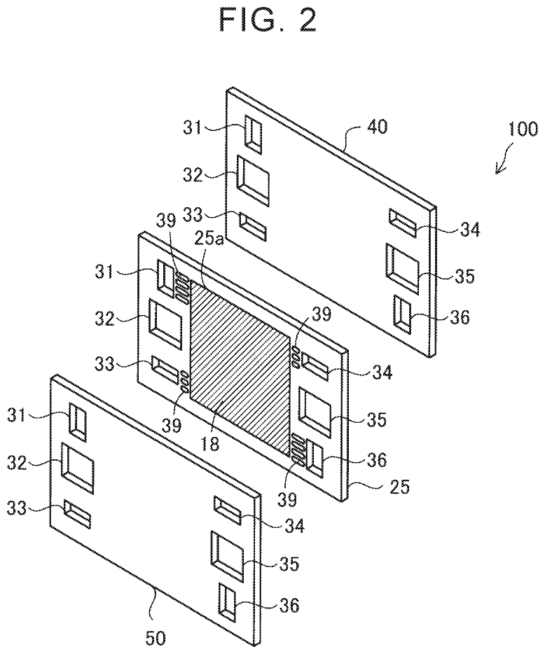

FIG. 2 is an exploded perspective view schematically illustrating a schematic configuration of the power generation cell 100. Note that FIGS. 1, 2 and other drawings described below each schematically illustrate a state of each part in the fuel cell of the present embodiment. Accordingly, the size of each part illustrated herein does not indicate a specific size. The power generation cell 100 includes a membrane electrode gas diffusion layer assembly 18 (hereinafter also referred to as the MEGA 18), gas separators 40, 50, and a first resin frame 25.

The MEGA 18 includes a membrane electrode assembly (hereinafter also referred to as MEA) and a pair of gas diffusion layers sandwiching the MEA therebetween. The MEA includes an electrolyte membrane, an anode, and a cathode, and the anode and the cathode are catalyst electrode layers formed on surfaces of the electrolyte membrane. The first resin frame 25 holds the MEA by surrounding an outer peripheral portion of the MEGA 18, namely, an outer peripheral portion of the MEA. A structure in which the MEGA 18 is joined to the first resin frame 25 is also referred to as a “first frame joining body.” The first frame joining body is sandwiched between the gas separators 40, 50. A surface of the MEGA 18 on a side where the anode is formed on the electrolyte membrane faces the gas separator 40, and an inside-cell fuel gas passage through which fuel gas flows is formed between the MEGA 18 and the gas separator 40. A surface of the MEGA 18 on a side where the cathode is formed on the electrolyte membrane faces the gas separator 50, and an inside-cell oxidation gas passage through which oxidation gas flows is formed between the MEGA 18 and the gas separator 50. The gas separators 40, 50 provided in the power generation cell 100 are also referred to as “first gas separators.”

In the MEGA 18, the electrolyte membrane is a proton conducting ion-exchange membrane made of a polyelectrolyte material, e.g., fluororesin, and exhibits good proton conductivity in a wet condition. The anode and the cathode are porous bodies having air holes and are formed, for example, such that conductive particles carrying a catalyst such as platinum or platinum alloy, e.g., carbon particles, are coated with a polymer electrolyte having proton conductivity. The gas diffusion layer is constituted by a member having gas permeability and electronic conductivity. The gas diffusion layer can be constituted by a metal member made of foam metal or metal mesh or a carbon member such as carbon cross or carbon paper, for example. The MEGA 18 is manufactured by pressing and joining the MEA to the gas diffusion layer, for example.

The gas separators 40, 50 are rectangular plate-shaped members. The gas separators 40, 50 are constituted by a gas impermeable conductive member, e.g., a carbon member made of dense carbon or the like formed by compressing carbon so as to be impermeable to gases, or a metal member made of stainless steel by press molding. Although not illustrated in FIG. 2, surfaces of the gas separators 40, 50 in the present embodiment have irregular shapes for forming the inside-cell fuel gas passage, the inside-cell oxidation gas passage, and the inter-cell refrigerant passage that have been described above.

The first resin frame 25 is formed by use of resin such as thermoplastic resin and has an outer shape formed in a rectangular frame shape. A central opening 25a of the first resin frame 25 is a retainer region for the MEGA 18 (the MEA). When the MEA is joined to the first resin frame 25 so that the MEA covers the opening 25a, gas sealing is performed in a part between the inside-cell fuel gas passage and the inside-cell oxidation gas passage in the power generation cell 100. Further, as illustrated in FIG. 2, the first resin frame 25 is provided with four slit portions 39. The slit portions 39 will be described later in detail.

As a material for forming the first resin frame 25, modified polyolefin such as modified polypropylene to which adhesiveness is given by introduction of a functional group (e.g., ADMER (registered trademark) made by Mitsui Chemicals, Incorporated) can be used, for example. The first resin frame 25 is bonded to the gas separators 40, 50 by hot-press. As the first resin frame 25 is made of modified polyolefin to which adhesiveness is given as described above, the first resin frame 25 can be easily bonded by hot-press to the gas separators 40, 50. Alternatively, in a case where the first resin frame 25 is made of resin that does not have adhesiveness particularly, a layer made of an adhesive and exhibiting adhesiveness by hot-press may be provided on surfaces of the first resin frame 25, for example. In this case, for the first resin frame 25, a resin selected from polypropylene (PP), phenolic resin, epoxy resin, polyethylene terephthalate (PET), and polyethylene naphthalate (PEN) can be used, for example. The layer made of the adhesive to be provided on the surfaces of the first resin frame 25 should contain a silane coupling agent, for example.

In parts near outer peripheries of the gas separators 40, 50 and the first resin frame 25, manifold holes 31 to 36 to form manifolds are provided at positions where the manifold holes 31 to 36 overlap each other in the laminating direction of the fuel cell stack 10. The manifold holes 31 form the oxidation gas supply manifold 131, the manifold holes 32 form the refrigerant supply manifold 132, the manifold holes 33 form the fuel gas discharge manifold 133, the manifold holes 34 form the fuel gas supply manifold 134, the manifold holes 35 form the refrigerant discharge manifold 135, and the manifold holes 36 form the oxidation gas discharge manifold 136.

As illustrated in FIG. 2, the first resin frame 25 of the present embodiment includes the slit portions 39 provided near the manifold holes 31, 33, 34, 36 and at positions close to the opening 25a where the MEGA 18 is placed. Each of the slit portions 39 includes slits as a plurality of elongated through-holes extending from the vicinity of an outer periphery of a corresponding one of the manifold holes 31, 33, 34, 36 toward the vicinity of an outer periphery of the MEGA 18. When the first resin frame 25 is sandwiched between the gas separators 40, 50, the slits form communication passages together with the irregular shapes formed on the surfaces of the gas separators 40, 50 so that each of the manifold holes 31, 33, 34, 36 communicates with its corresponding inside-cell gas passage via its corresponding communication passage. That is, when the first resin frame 25 is laminated with the gas separators 40, 50 so as to be assembled to the fuel cell stack 10, fuel-gas manifolds constituted by the manifold holes 33, 34 communicate with the inside-cell fuel gas passage via their corresponding slit portions 39, and oxidation-gas manifolds constituted by the manifold holes 31, 36 communicate with the inside-cell oxidation gas passage via their corresponding slit portions 39. The slit portion 39 provided near the manifold hole 34 forming the fuel gas supply manifold 134 and the slit portion 39 provided near the manifold hole 33 forming the fuel gas discharge manifold 133 are collectively referred to as a “first fuel gas communication structure.” Further, the slit portion 39 provided near the manifold hole 31 forming the oxidation gas supply manifold 131 and the slit portion 39 provided near the manifold hole 36 forming the oxidation gas discharge manifold 136 are collectively referred to as a “first oxidation gas communication structure.”

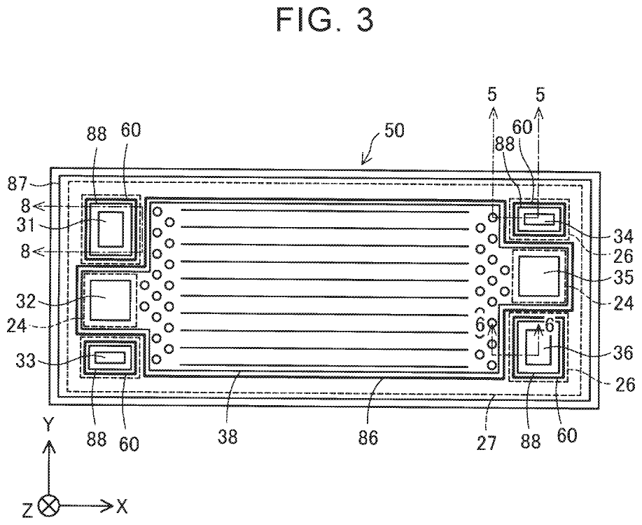

FIG. 3 is a plan view illustrating a state when the gas separator 50 is viewed from a surface different from a surface facing the first resin frame 25. As described above, the gas separator 50 is provided with six manifold holes 31 to 36. Among four sides of the outer periphery of the gas separator 50, the manifold holes 31 to 33 are formed along one of two sides extending in the Y-direction, and the manifold holes 34 to 36 are formed along the other one of the two sides extending in the Y-direction.

As illustrated in FIG. 3, gaskets 60, 86 are provided on the surface of the gas separator 50, the surface being illustrated in FIG. 3. When the power generation cells 100 are laminated, the gaskets 60, 86 seal passages formed between the gas separator 50 of one of adjacent power generation cells 100 and the gas separator 40 of the other one of the adjacent power generation cells 100. More specifically, the gasket 86 collectively seals refrigerant manifolds constituted by the manifold holes 32, 35 and the inter-cell refrigerant passage. Further, the gaskets 60 seal gas manifolds constituted by the manifold holes 31, 33, 34, 36 between the cells. The gaskets 60, 86 formed on respective gas separators 50 of the power generation cells 100 are provided at positions where they overlap each other in the laminating direction. The gaskets 60, 86 can be constituted by an elastic body. The elastic body to be used is, for example, rubber or thermoplastic elastomer.

In FIG. 3, positions where the gaskets 60, 86 are formed linearly on the gas separator 50 are indicated by thick lines, and positions where linear projection portions 38, 87, 88 provided on the gas separator 50 are formed are indicated by thin lines. In the gas separator 40 (not shown) adjacent to the gas separator 50, projection portions facing the projection portions 38, 87, 88 are formed at positions where they overlap the projection portions 38, 87, 88 in the laminating direction. The projection portions provided at positions where they overlap each other in the laminating direction are provided such that, when the power generation cells 100 are laminated, head portions of the projection portions provided in the gas separator 40 included in one of adjacent power generation cells 100 make contact with head portions of the projection portions 38, 87, 88 provided in the gas separator 50 included in the other one of the adjacent power generation cells 100. These projection portions are structures to secure the strength of the fuel cell stack 10.

Further, in FIG. 3, positions of adhesive sealing portions 24, 26, 27 provided on a back side to the surface illustrated in FIG. 3 and formed linearly between the gas separator 50 and the first resin frame 25 overlapping each other are indicated by broken lines. At the adhesive sealing portions 24, 26, 27, the first resin frame 25 is airtightly bonded to the gas separators 40, 50. The adhesive sealing portion 24 seals the refrigerant manifolds constituted by the manifold holes 32, 35. The adhesive sealing portions 26 surround and seal the gas manifolds constituted by the manifold holes 31, 33, 34, 36 in parts other than parts where the slit portions 39 are formed. The adhesive sealing portion 27 is provided along the outer peripheries of the gas separator 50 and the first resin frame 25 and seals the inside-cell fuel gas passage and the inside-cell oxidation gas passage formed in the power generation cell 100. The adhesive sealing portions 24, 26, 27 formed on the gas separators 40, 50 in the power generation cell 100 are provided at positions where they overlap each other in the laminating direction.

### (A-3) Structure of Non-power Generation Cell:

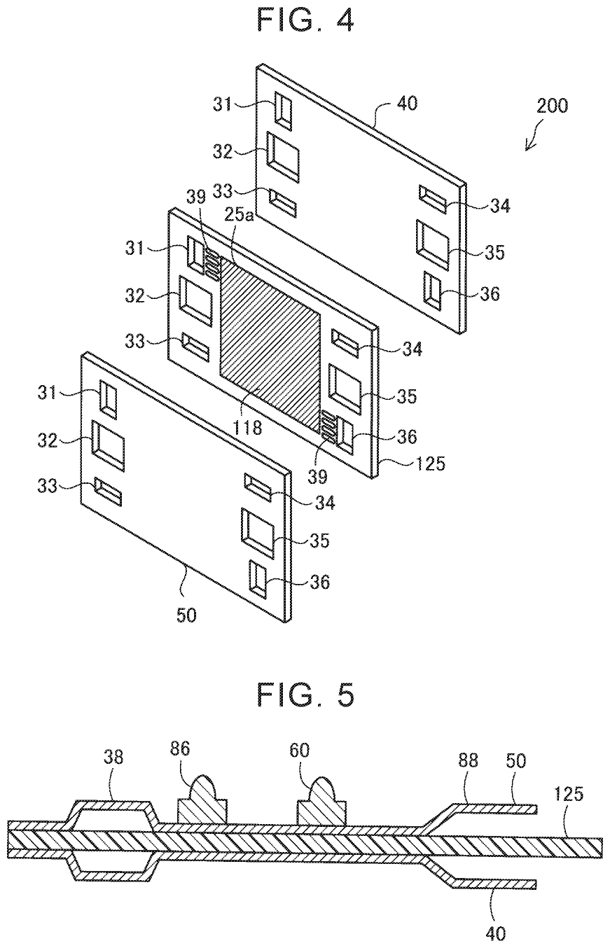

FIG. 4 is an exploded perspective view illustrating a schematic configuration of the non-power generation cell 200. The non-power generation cell 200 includes the gas separators 40, 50 as members common to the power generation cell 100. The gas separators 40, 50 provided in the non-power generation cell 200 are also referred to as “second gas separators.” The non-power generation cell 200 further includes a second resin frame 125 instead of the first resin frame 25 provided in the power generation cell 100, and a conductive member 118 instead of the MEGA 18.

The second resin frame 125 is different from the first resin frame 25 in the number of slit portions 39. In the second resin frame 125, the same reference numeral is assigned to a part common to the first resin frame 25. The second resin frame 125 includes the slit portions 39 near the manifold holes 31, 36 constituting the oxidation-gas manifolds, similarly to the first resin frame 25. However, differently from the first resin frame 25, the slit portions 39 are not provided near the manifold holes 33, 34 constituting the fuel-gas manifolds. In the second resin frame 125, the slit portion 39 provided near the manifold hole 31 constituting the oxidation gas supply manifold 131 and the slit portion 39 provided near the manifold hole 36 constituting the oxidation gas discharge manifold 136 are collectively referred to as a “second oxidation gas communication structure.”

The conductive member 118 is constituted by a porous conductive member. More specifically, the conductive member 118 in the present embodiment has a structure in which two gas diffusion layers similar to the two gas diffusion layers provided in the power generation cell 100 are provided to overlap each other. Such a conductive member 118 is placed in the central opening 25a of the second resin frame 125 and is joined to the second resin frame 125. A structure in which the conductive member 118 is joined to the second resin frame 125 is also referred to as a “second frame joining body.” In the non-power generation cell 200, the conductive member 118 makes contact with inner surfaces of the gas separators 40, 50.

The non-power generation cell 200 includes gaskets and adhesive sealing portions similarly to the power generation cell 100. That is, as illustrated in FIG. 3, the gaskets 60, 86 are provided on a surface of the gas separator 50 of the non-power generation cell 200, the surface being a surface on the inter-cell refrigerant passage side, and the adhesive sealing portions 24, 26, 27 are formed between the second resin frame 125 and each of the gas separators 40, 50.

Since the second resin frame 125 of the non-power generation cell 200 does not include the slit portions 39 near the manifold holes 33, 34 constituting the fuel-gas manifolds, the flow of fuel gas between the inside of the non-power generation cell 200 and each of the fuel gas supply manifold 134 and the fuel gas discharge manifold 133 is blocked. Since the second resin frame 125 includes the slit portions 39 provided near the manifold holes 31, 36 constituting the oxidation-gas manifolds, oxidation gas flows from the oxidation gas supply manifold 131 to the oxidation gas discharge manifold 136 via a space inside the non-power generation cell 200. In the present embodiment, since the conductive member 118 joined to the second resin frame 125 is a porous body, spaces formed between the gas separators 40, 50 communicate with each other without being blocked by the conductive member 118. On this account, oxidation gas flowing into the non-power generation cell 200 can flow both through the space on the gas separator 40 side in the conductive member 118 and through the space on the gas separator 50 side in the conductive member 118. The spaces thus formed between the gas separators 40, 50 in the non-power generation cell 200 such that oxidation gas flows through the spaces are also referred to as a “non-power generation cell inner space.”

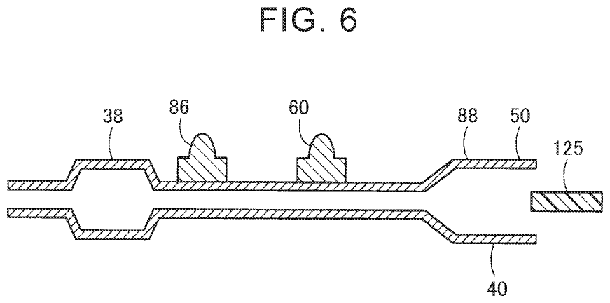

FIG. 5 is a sectional schematic view illustrating a state of a part near the manifold hole 34 in the non-power generation cell 200 at a position overlapping, in the laminating direction, with a position where the slits are formed in the power generation cell 100. FIG. 6 is a sectional schematic view illustrating a state of a part of the non-power generation cell 200 at a position where the slits are formed near the manifold hole 36. A position of the section illustrated in FIG. 5 is illustrated as a section 5-5 in FIG. 3, and a position of the section illustrated in FIG. 6 is illustrated as a section 6-6 in FIG. 3. FIG. 5 illustrates a state where a part between the fuel gas supply manifold 134 and the non-power generation cell inner space is closed, and FIG. 6 illustrates a state where a part between the oxidation gas discharge manifold 136 communicates with the non-power generation cell inner space via the slit.

### (A-4) Manufacturing Method for Fuel Cell:

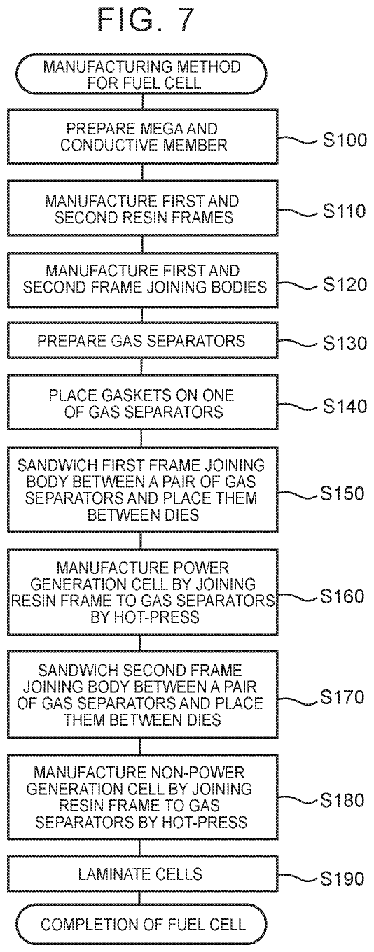

FIG. 7 is a process drawing illustrating a manufacturing method for a fuel cell in the present embodiment. At the time of manufacturing the fuel cell, first, the MEGA 18 for the power generation cell 100 and the conductive member 118 for the non-power generation cell 200 are prepared (step S100). Then, the first resin frame 25 and the second resin frame 125 are manufactured (step S110). The first resin frame 25 is different from the second resin frame 125 only in the arrangement (the number) of the slit portions 39. In step S110, slit portions that should be provided in a resin frame is formed by one punching per resin frame. On this account, in step S110, the first resin frame 25 and the second resin frame 125 are manufactured by changing the arrangement (the number) of punching blades to be placed in a punching die for use in punching.

After that, the MEGA 18 prepared in step S100 is joined to the first resin frame 25 manufactured in step S110 so that the first frame joining body is manufactured, and the conductive member 118 prepared in step S100 is joined to the second resin frame 125 manufactured in step S110 so that the second frame joining body is manufactured (step S120). In the MEGA 18 of the present embodiment, an outer peripheral portion of the electrolyte membrane has a region where the electrolyte membrane is exposed without being covered with the cathode and the gas diffusion layer. At the time of joining the MEGA 18 to the first resin frame 25 in step S120, the region where the electrolyte membrane is exposed is bonded to an inner peripheral portion of the first resin frame 25, the inner peripheral portion forming the central opening 25a. Such bonding should be performed, for example, such that an adhesive layer containing a UV (ultraviolet rays) curable adhesive is provided in a bonding part in the first resin frame 25 and is subjected to UV irradiation. As the UV curable adhesive, an adhesive containing polyisobutylene or butyl rubber can be used, for example. In step S120, it is not necessary to perform the joining of the conductive member 118 to the second resin frame 125 over the whole outer peripheral portion of the conductive member 118, and a part of the outer peripheral portion of the conductive member 118 (e.g., four corners of the conductive member 118) may be joined to the second resin frame 125. The joining can be performed by ultrasonic joining, for example.

Further, a plurality of gas separators 40, 50 is prepared as common members in the power generation cell 100 and the non-power generation cell 200 (step S130). Then, the gaskets 60, 86 are placed on a first surface of the gas separator 50 (step S140). The gaskets 60, 86 are formed by use of a die manufactured in accordance with shapes of the gaskets 60, 86. The gaskets 60, 86 should be formed on the gas separator 50 by injection molding, for example. Alternatively, the gaskets 60, 86 molded in advance may be bonded onto the gas separator 50 by use of an adhesive, for example.

Subsequently, the first frame joining body is sandwiched between a pair of gas separators 40, 50, and the gas separators 40, 50 and the first frame joining body are placed between dies for hot-press (step S150). More specifically, the first frame joining body is sandwiched between the gas separators 40, 50 so that a surface of the gas separator 50 that is not provided with the gaskets 60, 86 makes contact with the first frame joining body. Then, hot-press is performed to bond the first resin frame 25 to the gas separators 40, 50 (step S160), and hereby, the power generation cell 100 is manufactured. In the step of hot-press in step S160, the adhesive sealing portions 24, 26, 27 are formed between the first resin frame 25 and each of the gas separators 40, 50.

Further, the second frame joining body is sandwiched between a pair of gas separators 40, 50, and the gas separators 40, 50 and the second frame joining body are placed between dies for hot-press (step S170). More specifically, the second frame joining body is sandwiched between the gas separators 40, 50 so that a surface of the gas separator 50 that is not provided with the gaskets 60, 86 makes contact with the second frame joining body. Then, hot-press is performed to bond the second resin frame 125 to the gas separators 40, 50 (step S180), and hereby, the non-power generation cell 200 is manufactured. In the step of hot-press in step S180, the adhesive sealing portions 24, 26, 27 are formed between the second resin frame 125 and each of the gas separators 40, 50. In step S170 and step S180, the dies common to step S150 and step S160 can be used as the dies for hot-press.

After that, members including the power generation cell 100 manufactured in step S160 and the non-power generation cell 200 manufactured in step S180 are laminated as illustrated in FIG. 1 (step S190), and a laminated body obtained herein is fastened in the laminating direction. Hereby, the fuel cell is manufactured.

In the fuel cell of the present embodiment configured as described above, it is not necessary to provide, in the non-power generation cell 200, gaskets different from the gaskets provided in the power generation cell 100 in order to prevent the flow of either of fuel gas and oxidation gas in the non-power generation cell 200. On this account, for example, it is not necessary to separately prepare dies different from dies for use in the manufacture of the power generation cell 100 as the dies for forming gaskets on the gas separators 40, 50 of the non-power generation cell 200. This makes it possible to restrain a manufacturing cost from increasing due to provision of the non-power generation cell 200.

In the present embodiment, the power generation cell 100 and the non-power generation cell 200 can use the gas separators 40, 50 formed in the same manner. Further, in the present embodiment, the first resin frame 25 and the second resin frame 125 can be manufactured by use of frame-shaped members formed in the same manner. That is, the first resin frame 25 and the second resin frame 125 can be manufactured by performing simple and easy machining on the frame-shaped members thus formed in the same manner, such that punching is performed on the frame-shaped members by changing the arrangement (the number) of punching blades to be placed in the punching die. This can simplify the configuration and the manufacturing process of the fuel cell, thereby making it possible to restrain the manufacturing cost from increasing due to provision of the non-power generation cell 200.

Further, in the present embodiment, out of fuel gas and oxidation gas as reactant gases, only oxidation gas flows in the non-power generation cell 200. In such a configuration, it is not necessary to supply fuel gas to the non-power generation cell 200. Accordingly, in comparison with a case where fuel gas is supplied to the non-power generation cell 200, it is possible to reduce energy to drive a device for supplying fuel gas, e.g., a device such as a pump for pressurizing fuel gas to be supplied to the fuel cell.

Further, by introducing oxidation gas into the non-power generation cell 200, it is possible to restrain an influence on power generation performance of the fuel cell and to increase a water discharge property from a passage where oxidation gas flows. Liquid water as well as reactant gases can flow from the supply manifolds for fuel gas and oxidation gas into the inside-cell fuel gas passage, the inside-cell oxidation gas passage, and the non-power generation cell inner space where the reactant gases flow. When liquid water flows in, the power generation performance of the power generation cell 100 can be affected due to the presence of liquid water in the gas passages. However, in the non-power generation cell 200, even when liquid water flows in, the power generation performance is not affected. By introducing oxidation gas into the non-power generation cell inner space in the non-power generation cell 200, it is possible to discharge water continuously.

Further, in the present embodiment, a porous member similar to the gas diffusion layer is used as the conductive member 118, and oxidation gas flows through the whole non-power generation cell inner space formed between the gas separators 40, 50 in the non-power generation cell 200. Accordingly, a passage resistance at the time when oxidation gas flows through the non-power generation cell inner space is smaller than a passage resistance at the time when oxidation gas flows through the inside-cell oxidation gas passage formed between the MEGA and the gas separator 50. As a result, it is possible to increase the water discharge property via the non-power generation cell inner space.

Further, in the non-power generation cell 200 of the present embodiment, a porous member is used as the conductive member 118 so that the whole non-power generation cell inner space serves as an oxidation-gas passage. Accordingly, it is not necessary to secure a gas sealing property between the conductive member 118 and the second resin frame 125. On this account, differently from the power generation cell 100 that is necessary to secure a gas sealing property between the MEA and the first resin frame 25, it is possible to more simplify the structure of the non-power generation cell 200.

Note that the second resin frame 125 illustrated in FIG. 4 does not include the slit portions 39 near the manifold holes 33, 34. However, the slit portion 39 may be provided near either one of the manifold holes 33, 34. Even in such a configuration, the flow of fuel gas to the non-power generation cell inner space can be blocked.

### B. Second Embodiment

In the first embodiment, the shape of a passage constituted by the slit portion 39 provided in the second resin frame 125 of the non-power generation cell 200 is the same as the shape of a passage constituted by a corresponding slit portion 39 provided in the first resin frame 25 of the power generation cell 100, but they may have different shapes. As a second embodiment, the following describes a configuration in which the passage constituted by the slit portion 39 provided in the second resin frame 125 has a part with a sectional area smaller than that of the passage constituted by a corresponding slit portion 39 provided in the first resin frame 25. In the following description, the same reference numeral is assigned to a part common to the first embodiment. The second resin frame 125 in the second embodiment includes the slit portions 39 at similar positions in the second resin frame 125 in the first embodiment.

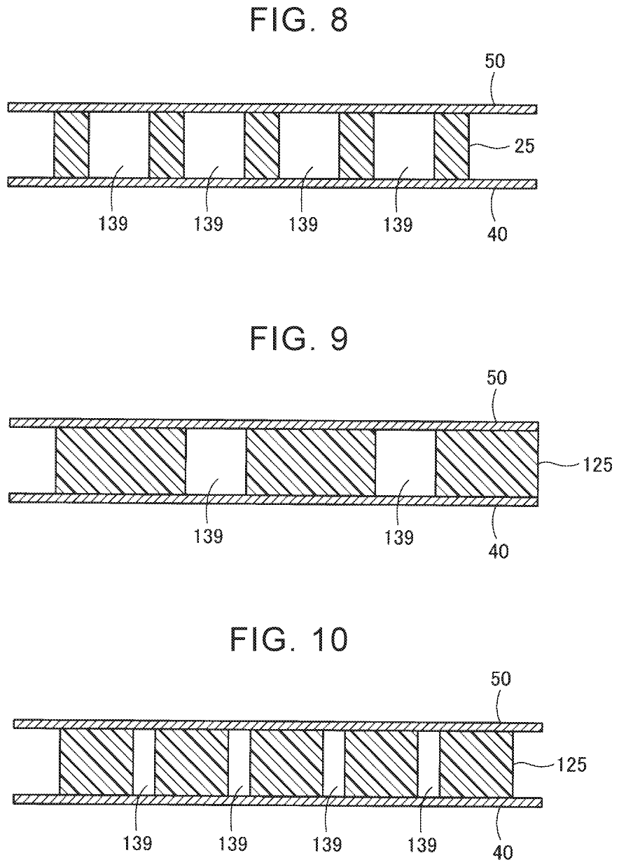

FIG. 8 is a sectional schematic view illustrating a state of a part including the slit portion 39 (the first oxidation gas communication structure) provided near the manifold hole 31 of the power generation cell 100. Further, FIG. 9 is a sectional schematic view illustrating a state of a part including the slit portion 39 (the second oxidation gas communication structure) provided near the manifold hole 31 of the non-power generation cell 200. Positions of the sections illustrated in FIGS. 8 and 9 are illustrated as a section 8-8 in FIG. 3. FIGS. 8 and 9 illustrates states of sections in a direction perpendicular to a direction where slits 139 provided in the slit portion 39 extend.

The second oxidation gas communication structure illustrated in FIG. 9 is configured such that the number of slits 139 is small and the distance between the slits is long in comparison with the first oxidation gas communication structure illustrated in FIG. 8. On this account, a passage sectional area of the second oxidation gas communication structure is smaller than a passage sectional area of the first oxidation gas communication structure. Note that the passage sectional area of the first oxidation gas communication structure or the second oxidation gas communication structure indicates an area obtained by adding up respective passage sectional areas of a plurality of slits 139 provided in the slit portion 39 in a section perpendicular to a flowing direction of oxidation gas. With such a configuration, it is possible to increase the passage resistance at the time when oxidation gas flows through the non-power generation cell 200. As a result, it is possible to restrain a decrease in flow rate of oxidation gas due to provision of the non-power generation cell 200, the oxidation gas flowing through the power generation cell 100 adjacent to the non-power generation cell 200 or the power generation cell 100 placed near the non-power generation cell 200. This makes it possible to increase battery performance.

With such a configuration, by reducing the number of slits 139 in the slit portion 39 provided in the second resin frame 125 (by increasing the distance between the slits) as described above, it is possible to increase the passage resistance at the time when oxidation gas flows through the non-power generation cell 200. Further, in the present embodiment, similarly to the first embodiment, by introducing oxidation gas into the whole non-power generation cell inner space without closing the central opening 25a of the resin frame by a gas impermeable member like the MEA, it is possible to restrain the passage resistance at the time when oxidation gas flows through the non-power generation cell 200 and to increase the water discharge property. Further, as described above, the conductive member 118 is constituted by a porous body and oxidation gas flows through the whole non-power generation cell inner space between the gas separators 40, 50. This makes it possible to decrease the passage resistance at the time when oxidation gas flows through the non-power generation cell 200. On this account, by changing the shape of the slit portion 39 to be provided in the second resin frame 125 or further changing a void fraction or the like of the conductive member 118 placed in the non-power generation cell inner space, it is possible to adjust the passage resistance at the time when oxidation gas flows through the non-power generation cell 200. By adjusting the passage resistance as such, it is possible to adjust the flow rate, the distribution ratio, and so on of oxidation gas in the non-power generation cell 200.

FIG. 10 is a sectional schematic view illustrating a state of the section 8-8 in the second resin frame 125 as a first modification of the second embodiment, similarly to FIG. 9. In the first modification of the second embodiment, the width of the passage section of each slit 139 provided in the second oxidation gas communication structure is smaller than the width of the passage section of each slit 139 provided in the first oxidation gas communication structure illustrated in FIG. 8. The distance between the slits in the second oxidation gas communication structure is longer than that in the first oxidation gas communication structure. On this account, the passage sectional area of the second oxidation gas communication structure is smaller than the passage sectional area of the first oxidation gas communication structure.

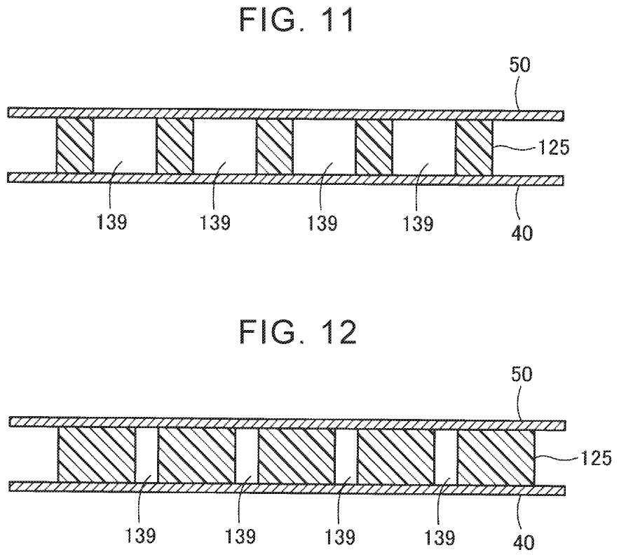

FIG. 11 is a sectional schematic view illustrating a state of the section 8-8 in the second resin frame 125 as a second modification of the second embodiment, similarly to FIG. 9. In the second modification of the second embodiment, the height of the passage section of each slit 139 provided in the second oxidation gas communication structure is smaller than the height of the passage section of each slit 139 provided in the first oxidation gas communication structure illustrated in FIG. 8. On this account, the passage sectional area of the second oxidation gas communication structure is smaller than the passage sectional area of the first oxidation gas communication structure.

For example, when the pressure at the time of hot-press in step S180 in FIG. 7 is increased to be larger than the pressure at the time of hot-press in step S160, the height of the passage section of each slit 139 provided in the second oxidation gas communication structure can be made smaller than the height of the passage section of each slit 139 provided in the first oxidation gas communication structure as described in the second modification of the second embodiment. That is, in a laminated body in which the second frame joining body is sandwiched between the gas separators 40, 50, at the time when the gas separators 40, 50 are joined to the second resin frame 125 by pressing the laminated body at a position overlapping with the second oxidation gas communication structure in the laminating direction, the pressure to be applied should be increased as compared to the pressure at the time of manufacture of the power generation cell 100. Hereby, a degree to crush the slit portion 39 at the time of hot-press is made large, so that the height of the passage section of the slit 139 can be decreased, that is, the distance between the gas separators 40, 50 in a part including the slit 139 can be decreased. At this time, it is not necessary to crush the slit portion 39 so that the heights of respective passage sections of the whole slits 139 provided in the second oxidation gas communication structure are decreased. The slit portion 39 should be at least partially crushed. Hereby, the passage constituted by the second oxidation gas communication structure has a part with a sectional area smaller than that of the passage constituted by the first oxidation gas communication structure. This makes it possible to increase the passage resistance at the time when oxidation gas flows through the non-power generation cell 200 to be larger than the passage resistance at the time when oxidation gas flows through the power generation cell 100. In a case where the slit portion 39 is partially crushed, the slits 139 included in the slit portion 39 may be crushed equally, or the slit portion 39 may be crushed dispersedly, for example. Note that, at the time when the non-power generation cell 200 in which the height of the passage section of each slit 139 is decreased and the distance between the gas separators 40, 50 is shortened is assembled in the fuel cell stack 10, a decreased amount of the height is absorbed by the gaskets 60, 86, so that a sealing property in the fuel cell stack 10 is secured.

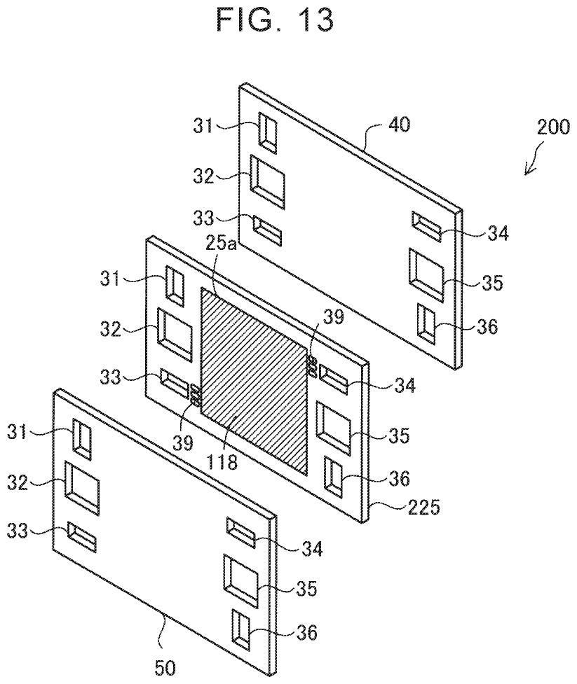

FIG. 12 is a sectional schematic view illustrating a state of the section 8-8 in the second resin frame 125 as a third modification of the second embodiment, similarly to FIG. 9. The fuel cell in the third modification of the second embodiment has both features of the first modification of the second embodiment and the second modification of the second embodiment. That is, the width of the passage section of each slit 139 provided in the second oxidation gas communication structure is smaller than the width of the passage section of each slit 139 provided in the first oxidation gas communication structure illustrated in FIG. 8, and the distance between the slits in the second oxidation gas communication structure is longer than that in the first oxidation gas communication structure. Further, the height of the passage section of each slit 139 provided in the second oxidation gas communication structure is smaller than the height of the passage section of each slit 139 provided in the first oxidation gas communication structure illustrated in FIG. 8. As such, the features illustrated in FIGS. 9 to 11 may be combined as appropriate.

Note that it is not necessary that the configuration in which the passage sectional area of the slit portion 39 in the second resin frame 125 is made smaller than the passage sectional area of the slit portion 39 in the first resin frame 25 be applied to both the slit portion 39 provided near the manifold hole 31 and the slit portion 39 provided near the manifold hole 36 in the second oxidation gas communication structure, and the configuration may be applied to either one of them. The passage constituted by at least one of two slit portions 39 constituting the second oxidation gas communication structure of the second resin frame 125 should have a part with a sectional area smaller than that of the passage constituted by the first oxidation gas communication structure of the first resin frame 25.

### C. Third Embodiment

FIG. 13 is an exploded perspective view illustrating a schematic configuration of the non-power generation cell 200 included in a fuel cell of a third embodiment. In the following description, the same reference numeral is assigned to a part common to the first embodiment.

The non-power generation cell 200 of the third embodiment includes a second resin frame 225 instead of the second resin frame 125. Differently from the second resin frame 125, the second resin frame 225 does not include the slit portion 39 provided near the manifold hole 31 and the slit portion 39 provided near the manifold hole 36 (the second oxidation gas communication structure). Instead of this, the second resin frame 225 includes the slit portion 39 provided near the manifold hole 34 and the slit portion 39 provided near the manifold hole 33. The slit portion 39 provided near the manifold hole 34 and the slit portion 39 provided near the manifold hole 33 are collectively referred to as a “second fuel gas communication structure.” On this account, only fuel gas flows through the non-power generation cell inner space formed between the gas separators 40, 50 in the non-power generation cell 200 of the third embodiment.

With such a configuration, it is possible to obtain an effect similar to that in the first embodiment in which only oxidation gas flows through the non-power generation cell inner space. At this time, in the third embodiment, since fuel gas flows through the non-power generation cell inner space, it is possible to obtain an effect to improve a water discharge property from the fuel gas passage instead of the oxidation gas passage and to reduce energy necessary to supply oxidation gas. Further, the second embodiment and the modifications of the second embodiment may be applied to the third embodiment. That is, the passage constituted by the second fuel gas communication structure in the second resin frame 225 may have a part with a sectional area smaller than that of the passage constituted by the first fuel gas communication structure in the first resin frame 25.

Note that the second resin frame 225 illustrated in FIG. 13 does not include the slit portions 39 provided near the manifold holes 31, 36, but the slit portion 39 may be provided near either one of the manifold holes 31, 36. Even in such a configuration, the flow of oxidation gas to the non-power generation cell inner space can be blocked.

### D. Fourth Embodiment

FIG. 14 is an exploded perspective view illustrating a schematic configuration of the non-power generation cell 200 included in a fuel cell of a fourth embodiment. In the following description, the same reference numeral is assigned to a part common to the first embodiment.

The non-power generation cell 200 of the fourth embodiment includes a second resin frame 325 instead of the second resin frame 125. Differently from the second resin frame 125, the second resin frame 325 does not include the slit portions 39. On this account, the second resin frame 325 is bonded to the surfaces of the gas separators 40, 50 so that the flow of fuel gas between the non-power generation cell inner space and each of the fuel gas supply manifold 134 and the fuel gas discharge manifold 133 is blocked, and the flow of oxidation gas between the non-power generation cell inner space and each of the oxidation gas supply manifold 131 and the oxidation gas discharge manifold 136 is blocked.

With such a configuration, similarly to the first embodiment, it is possible to restrain the manufacturing cost from increasing due to provision of the non-power generation cell 200. Further, a member used to manufacture the first resin frame 25, the member being before the slit portions 39 are formed, can be used for the second resin frame 325. This makes it possible to simplify the manufacturing process of manufacturing the non-power generation cell 200 in which the circulation of reactant gases is blocked. Further, both reactant gases (fuel gas and oxidation gas) are not supplied to the non-power generation cell 200. Accordingly, in comparison with a case where at least either one of the reactant gases is supplied to the non-power generation cell 200, it is possible to reduce energy to drive devices (a pump, a compressor, and so on) for supplying the reactant gases.

Note that the second resin frame 325 illustrated in FIG. 14 does not include the slit portions 39 at all. However, the second resin frame 325 may include the slit portion 39 corresponding to any of four slit portions 39 provided in the first resin frame 25. For example, in the second resin frame, the slit portion 39 may be provided near either one of the manifold hole 31 and the manifold hole 36. Alternatively, the slit portion 39 may be provided near either one of the manifold hole 33 and the manifold hole 34. As either one of an inlet and an outlet via which a reactant gas flows through the non-power generation cell inner space is blocked, the flow of the reactant gas to the non-power generation cell inner space can be blocked.

### E. Other Embodiments

(E1) In each of the above embodiments, one non-power generation cell 200 is placed on each end of the fuel cell stack 10, but other configurations may be employed. Various modifications can be made as follows, for example: the non-power generation cell 200 is placed only in one of both ends of the fuel cell stack 10.

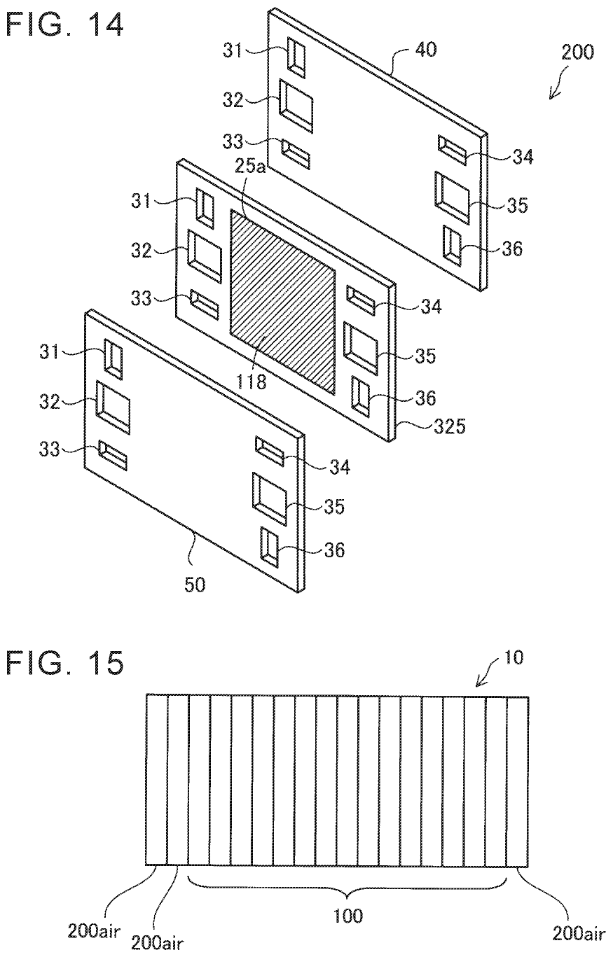

FIG. 15 is an explanatory view illustrating a schematic configuration of the fuel cell stack 10 as an example of other embodiments. In FIG. 15, the current collector plates 300, 310, the insulating plates 320, 330, and the end plates 340, 350 (see FIG. 1) placed in end portions of the fuel cell stack 10 are not illustrated. The fuel cell stack 10 in FIG. 15 is configured such that two non-power generation cells of the first embodiment are placed on a first end portion of the fuel cell stack 10 in a laminated manner, and one non-power generation cell of the first embodiment is placed on a second end portion of the fuel cell stack 10. Oxidation gas flows through the non-power generation cells of the first embodiment. In FIG. 15, such non-power generation cells are each illustrated as a non-power generation cell 200air. With such a configuration, the water discharge property in the oxidation-gas passage is increased, thereby making it possible to restrain liquid water in the oxidation-gas passage from affecting power generation performance of the fuel cell.

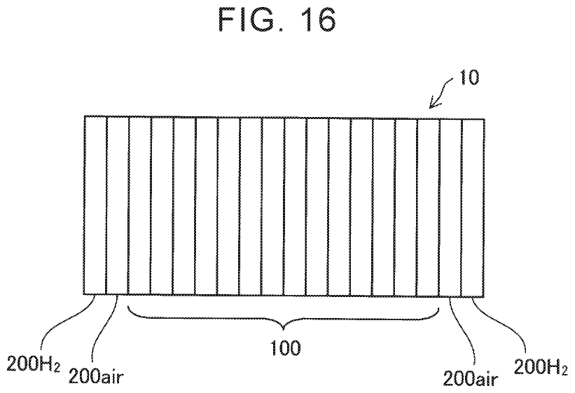

FIG. 16 is an explanatory view illustrating a schematic configuration of the fuel cell stack 10 as another example of other embodiments in a similar manner to FIG. 15. The fuel cell stack 10 in FIG. 16 is configured such that one non-power generation cell of the first embodiment and one non-power generation cell of the third embodiment are placed in each end portion of the fuel cell stack 10 in a laminated manner in this order toward the outer side of the fuel cell stack 10. Oxidation gas flows through the non-power generation cell of the first embodiment, and fuel gas flows through the non-power generation cell of the third embodiment. In FIG. 16, the non-power generation cell of the first embodiment is illustrated as the non-power generation cell 200air, and the non-power generation cell of the third embodiment is illustrated as a non-power generation cell 200H2.With such a configuration, the water discharge property in the oxidation-gas passage and the water discharge property in the fuel-gas passage are both increased, thereby making it possible to restrain liquid water in the reactant-gas passages from affecting power generation performance of the fuel cell.

Alternatively, the non-power generation cell of the fourth embodiment may further be placed on an outer side of each end of the fuel cell stack 10 illustrated in FIG. 15 or 16. The flows of the reactant gases are blocked in the non-power generation cell of the fourth embodiment. Further, a part where the non-power generation cell is placed may be a part where the water discharge property is desired to be increased other than the end portions of the fuel cell stack 10. As such, types of non-power generation cells, the number of non-power generation cells to be placed, the order of placement, a part where the non-power generation cell is placed, and so on should be set appropriately in accordance with desired thermal insulation performance and water discharge performance.

(E2) In each of the above embodiments, the non-power generation cell 200 includes the conductive member 118 that is a porous member. However, the non-power generation cell 200 may have other configurations. In a case where only one reactant gas flows through the non-power generation cell 200 like the first to third embodiments, or in a case where the flows of the reactant gases to the non-power generation cell 200 are blocked, the conductive member provided in the non-power generation cell 200 may include a gas impermeable metal sheet, and gas diffusion layers placed on surfaces of the metal sheet, for example. Then, the gas impermeable metal sheet may be airtightly joined to the second resin frame so as to close the opening 25a, and a space inside the non-power generation cell 200 may be sectioned by the conductive member. In a case where such a conductive member is applied to the configuration in which only one reactant gas flows through the non-power generation cell 200 like the first to third embodiments, a space between either one of the gas separators 40, 50 and the conductive member serves as the “non-power generation cell inner space” through which the reactant gas flows.

(E3) In each of the above embodiments, the first and second fuel gas communication structures or the first and second oxidation gas communication structures formed in the first and second resin frames so that the passages inside the cells communicate with the manifolds are constituted by the slit portions 39 including slits as a plurality of through-holes. However, other configurations may be employed. For example, the fuel gas communication structure and the oxidation gas communication structure may be constituted by a plurality of grooves for forming the passages instead of the slits as through-holes.

(E4) In each of the above embodiments, each power generation cell 100 and each non-power generation cell 200 constituting the fuel cell each include a pair of gas separators 40, 50. However, other configurations may be employed. More specifically, a single gas separator may be shared between adjacent cells. For example, a gas separator may be shared between two adjacent power generation cells 100, an inside-cell fuel gas passage may be formed between the gas separator thus shared and an anode of one of the power generation cells 100, and an inside-cell oxidation gas passage may be formed between the gas separator thus shared and a cathode of the other one of the power generation cells 100.

(E5) The fuel cell in each of the above embodiments is a so-called inner-manifold type fuel cell in which the manifold holes 31 to 36 are provided in the gas separators 40, 50 and the first and second resin frames. However, other configurations may be employed. For example, the fuel cell may be configured such that manifolds are attached to an outer part of a fuel cell stack, and the manifolds are placed to be adjacent to gas separators and a resin frame, that is, a so-called outer-manifold type fuel cell may be employed. In either case, when non-power generation cells similar to those provided in each of the above embodiments are provided, it is possible to obtain effects similar to those in the above embodiments.

The present disclosure is not limited to the above embodiments and is achievable in various configurations within a range that does not deviate from the gist of the present disclosure. For example, technical features of the embodiments, corresponding to the technical features of the aspects described in SUMMARY, can be replaced or combined appropriately, in order to solve some or all of the problems described above or in order to achieve some or all of the above effects. Further, the technical features can be deleted appropriately if the technical features have not been described as essential in the present specification.

What is claimed is:

1. A fuel cell comprising a fuel cell stack in which a power generation cell and a non-power generation cell are laminated, the power generation cell being configured to generate electric power upon receipt of supply of fuel gas and oxidation gas, the non-power generation cell being configured not to generate electric power, wherein:
the power generation cell includes
a pair of first gas separators,
a membrane electrode assembly placed between the first gas separators, and
a first resin frame configured to hold the membrane electrode assembly by surrounding an outer periphery of the membrane electrode assembly, the first resin frame being sandwiched between the first gas separators;
the non-power generation cell includes
a pair of second gas separators,
a conductive member placed between the second gas separators and making contact with respective inner surfaces of the second gas separators, and
a second resin frame surrounding an outer periphery of the conductive member, the second resin frame being sandwiched between the second gas separators;
the first resin frame includes a first fuel gas communication structure configured to lead the fuel gas to a first surface of the membrane electrode assembly, and a first oxidation gas communication structure configured to lead the oxidation gas to a second surface of the membrane electrode assembly; and
the second resin frame includes either one of a second fuel gas communication structure configured to lead the fuel gas to between the second gas separators, and a second oxidation gas communication structure configured to lead the oxidation gas to between the second gas separators.

2. The fuel cell according to claim 1, wherein:
the second resin frame includes the second fuel gas communication structure; and
a passage constituted by the second fuel gas communication structure has a part with a sectional area smaller than a sectional area of a passage constituted by the first fuel gas communication structure.

3. The fuel cell according to claim 1, wherein:
the second resin frame includes the second oxidation gas communication structure; and
a passage constituted by the second oxidation gas communication structure has a part with a sectional area smaller than a sectional area of a passage constituted by the first oxidation gas communication structure.

4. The fuel cell according to claim 1, wherein the conductive member is a porous body.

5. A fuel cell comprising a fuel cell stack in which a power generation cell and a non-power generation cell are laminated, the power generation cell being configured to generate electric power upon receipt of supply of fuel gas and oxidation gas, the non-power generation cell being configured not to generate electric power, wherein:
the power generation cell includes
a pair of first gas separators,
a membrane electrode assembly placed between the first gas separators, and
a first resin frame configured to hold the membrane electrode assembly by surrounding an outer periphery of the membrane electrode assembly, the first resin frame being sandwiched between the first gas separators;
the non-power generation cell includes
a pair of second gas separators,
a conductive member placed between the second gas separators and making contact with respective inner surfaces of the second gas separators, and
a second resin frame surrounding an outer periphery of the conductive member, the second resin frame being sandwiched between the second gas separators;
the first resin frame includes a first fuel gas communication structure configured to lead the fuel gas to a first surface of the membrane electrode assembly, and a first oxidation gas communication structure configured to lead the oxidation gas to a second surface of the membrane electrode assembly; and
the second resin frame blocks introduction of the fuel gas to between the second gas separators and introduction of the oxidation gas to between the second gas separators.

6. A manufacturing method for the fuel cell according to claim 2, the manufacturing method comprising:
manufacturing a laminated body by sandwiching the conductive member and the second resin frame between the second gas separators;
joining the second gas separators to the second resin frame by pressurizing the laminated body in a laminating direction of the laminated body; and
pressing the laminated body at a position overlapping with the second fuel gas communication structure in the laminating direction at a time of the joining so that the sectional area of the passage constituted by the second fuel gas communication structure is made smaller than the sectional area of the passage constituted by the first fuel gas communication structure.

7. A manufacturing method for the fuel cell according to claim 3, the manufacturing method comprising:
manufacturing a laminated body by sandwiching the conductive member and the second resin frame between the second gas separators;
joining the second gas separators to the second resin frame by pressurizing the laminated body in a laminating direction of the laminated body; and
pressing the laminated body at a position overlapping with the second oxidation gas communication structure in the laminating direction at a time of the joining so that the sectional area of the passage constituted by the second oxidation gas communication structure is made smaller than the sectional area of the passage constituted by the first oxidation gas communication structure.
